(19) United States
(12) Patent Application Publication
(10) Pub. No.: US 2014/0279678 A1
(43) Pub. Date: Sep. 18, 2014

(54) Automated Cash Leveraging Facility to Provide Available Cash from Sweep Investments for Margin Financing

(71) Applicant: Steven M.H. Wallman, Great Falls, VA (US)

(72) Inventor: Steven M.H. Wallman, Great Falls, VA (US)

(73) Assignee: FOLIOfn, Inc., McLean, VA (US)

(21) Appl. No.: 13/803,115

(22) Filed: Mar. 14, 2013

(51) Int. Cl. G06Q 40/06

(52) U.S. Cl. CPC G06Q 40/06
USPC 705/36 R

(57) ABSTRACT

A computer-implemented trade and order management system that enables cash movement for providing margin financing to customers in brokerage accounts utilizing sweep vehicles on a cost-effective and efficient basis to provide expanded access to capital for brokerages. The computer-implemented method issues sells and buys of the cash sweep vehicles on a daily basis to generate cash and free credits in customer accounts or to reduce free credits and add to the sweep vehicle position in the accounts. The goal is to match the amount in the aggregate across all accounts of free credits with the aggregate of customer debits so as to result in a net zero free credit to customer debit position for the brokerage. This method involves a daily calculation across all pertinent accounts.

### BACKGROUND

The present invention relates generally to a computer implemented instrument cash movement system, and more particularly to a computer implemented instrument cash movement system for providing margin financing to customers in brokerage accounts.

Margin financing in brokerage accounts for customers is ordinarily provided by a brokerage, which either: i) provides its own capital; ii) utilizes free credits (i.e., cash) that are maintained in clients' accounts and not swept into a cash sweep vehicle (such as a money market mutual fund or a money market demand account at a bank); or iii) borrows from a third party, such as a bank to fund the customer borrowing. Each of these three methods has its advantages and disadvantages, but none is optimal especially for small or startup brokers.

Ordinarily, free credits consist of cash that is not swept off the books of the brokerage. As such, under current regulatory requirements, unless there are countervailing customer debits, the amount of the cash (i.e., the cash that is not swept off the books) must be “locked-up” in a reserve account, and withdrawn only upon a subsequent “lock-up” calculation that occurs generally weekly.

Sweep vehicles by contrast generally are used to move cash out of customers' accounts on a daily basis, which avoids the “lock-up” requirement.

For this reason, in part, brokerages have gravitated to sweep vehicles for their customer funds and to utilizing their own capital or borrowing funds from third party institutions, such as independent banks, to finance margin balances of their customers. Because this borrowing or self-funding remains costly, and for other reasons, many brokerages have acquired, been acquired by or otherwise have affiliated with banks with the result that customer debits (i.e., margin borrowings) are financed by the affiliated bank and the benefits of the margin loan are captured by the overall affiliated group.

As a result, the teaching has been to use sweep vehicles and affiliate with a bank, or else have significant internal capital to loan. Where brokerages are affiliated with banks (i.e., are owned by or own banks) the strategy of using a sweep vehicle and an affiliated bank's lending capacity is obvious. But where a brokerage is small or not so affiliated, having an alternative method of generating cash usable to finance customer debits remains critical to cash flow for such a brokerage.

Previously, brokerages would utilize free credits—cash of their customers' that is not swept—to help finance the margin loan. But the combination of the lock-up requirement, weekly windows for calculating the amounts available, volatility in the market, increased velocity with which customers can move money into or out of their brokerages, etc. all make utilizing free credits an expensive and inefficient mechanism that has gone into disuse.

The present invention is therefore directed to the problem of reversing this phenomenon and providing a cost-effective means for any sized brokerage to be able to finance, on a reasonable basis, its margin loans.

Moreover, the present invention is also directed to the problem of developing a system and method to enable a brokerage to utilize a sweep vehicle and still be able to generate free credits on an as needed, on demand basis, to finance customer debits.

### SUMMARY OF THE INVENTION

The present invention solves these and other problems by, inter alia, providing a computer-implemented trade and order management system for sweep vehicles depending on the amount of required customer free credits to satisfy customer debits. In short, the present invention provides a fourth alternative to the aforementioned three ways brokerages can finance margin trading, which fourth alternative leverages a combination of free credits in conjunction with, as opposed to in opposition to, a cash sweep vehicle program.

These and other advantages and aspects of the present invention will be apparent upon review of the following drawings and description.

### BRIEF DESCRIPTION OF THE DRAWINGS

FIG. 1 depicts an exemplary embodiment of a computerized trade and order management system for implementing the methods of the present invention set forth herein according to one aspect of the present invention.

FIG. 2 depicts an exemplary embodiment of a computer implemented method for managing cash in a brokerage according to another aspect of the present invention.

FIG. 3 depicts an exemplary embodiment of a computer implemented method for managing cash in a brokerage according to yet another aspect of the present invention.

### DETAILED DESCRIPTION

The present invention comprises a computer-implemented system that enables the generation of free credits from customer holdings in their sweep vehicles for the use of funding customer debits. The computer implemented system of the present invention can be implemented on existing brokerage servers or computers or on one or more separate computers or servers.

The present invention first employs a sweep vehicle, which can be: (i) a money market fund; or (ii) cash amounts held in a bank or program banks as money market demand accounts or other accounts, to which accounts the cash has been swept by the brokerage for the benefit of its customers.

The computer implemented method of the present invention issues sells and buys of the sweep vehicle. The amount of the buys or sells would ordinarily—and without the present invention—be determined solely by standard sweep activity relating to actions taken by the customer or related to activity in the customer's account, namely a customer's account buying or selling the sweep vehicle reflecting the movement of settling cash to or from such customer's account. This cash movement is due to the customer's selling securities (which will generate cash when the sell settles, usually on the third market day after the trade) or buying securities (which will require cash to be forwarded to the settlement account when the buy settles, usually on the third market day after the trade), from deposits or withdrawals of funds (cash) by or for the benefit of the customer (such as a wire transfer or a check being drawn on or deposited into that customer's account), or various other factors, such as cash dividends being paid on securities held in that customer's account.

Added to that sweep calculation by the method of the present invention is another calculation that is completely independent of any action taken by that customer, or any action related to securities held in such customer's account, or any other activity of any sort due to actions in such customer's account. According to the present invention, a calculation for one customer A (or A . . . N) is supplemented by actions taken by other customers B (or B to . . . N) in their separate accounts. When a customer B wants to margin securities in his account or otherwise create a customer debit in his account to be financed by the brokerage, the brokerage would obtain the funds to do so by selling some of the sweep vehicle in customer A's (or A . . . N's) account(s), thereby converting that sweep vehicle to free credits held in customer A's (or customer A . . . N's) the account(s). As a result, these free credits are now cash usable by the brokerage, which such cash the brokerage then loans to customer B (or B . . . N).

Because there is an exact or reasonably exact match of the amount of customer credits generated (i.e., the free credits) with the customer debits generated (i.e., the margin loan) there is little to no net excess customer credit that needs to be “locked-up” (there may still be a regulatory deposit such as a “haircut” but that is a small percentage of the amount that would otherwise need to be locked-up if there were no offsetting debits), which would ordinarily occur if the brokerage did not have a sweep program and allowed the customers' funds to remain in cash (thereby being free credits without offsetting debits thereby requiring a lock-up).

According to another aspect of the present invention, the calculation is dynamic and made daily as part of the sweep calculation. Moreover, the calculation is included in the cash movements under the sweep program. Therefore, the amount of generated free credits is increased or decreased on a daily basis to reduce or eliminate any potential lock-up and to provide a consistent and expandable source of financing for any reasonable amount of customer borrowing. By using the computer-implemented trade and order system, the operation can be utilized in a novel way across an unlimited number of accounts for an unlimited number of combinations of borrowers and account holders with excess cash.

### Exemplary Embodiment

Generating Orders

Turning to FIG. 1, shown therein is an exemplary embodiment of a computer-implemented method for managing the aforementioned sweep calculations and providing the trade and order management instructions for the sweep vehicle. Investors 1 . . . N (12a-12n) are coupled through network 13 to Central Server 11, which performs all of the calculations necessary for the methods described herein. Database 15 stores all relevant information for use by the Central Server 11. All trades are sent to the Market Interface Server 18. Each Investor 1 . . . N has an account established with the Central Server 11, and the account information is stored in database 15. Network 13 can be a public network, private network or the Internet. All communications can be via any communication method, including but not limited to wireless, wired, LAN, fiber, etc.

The method begins with open accounts containing: i) cash in a sweep vehicle; and ii) a pending debit caused by customers' buying securities on margin. On the processing cycle on the day immediately before the cash is required for settlement for the benefit of the accounts with pending debits, the aggregate amount of such pending debits is calculated by Central Server 11. This aggregated amount is then allocated by the Central Server for purposes of calculations only (that is, the debits are not actually placed in the accounts) to accounts in database 15 with cash in a sweep vehicle. This allocation can be done by the Central Server 11 in a number of ways: (i) pro rata based on the amount of cash sweep vehicle available, (ii) randomly, (iii) the largest cash sweep vehicle holdings first (or last), (iv) by having some customers affirmatively opt-in based on being paid a bonus to participate or otherwise. Once the allocation is complete, the cycle performed by the Central Server 11 adds those amounts to the ordinary sweep calculated amounts and sells (or buys less if an account would have had a buy based on the ordinary sweep activity greater than the amount of this debit calculated sell) of the sweep vehicle in connection with such accounts' holdings and places free credits in such customers' accounts. In other words, the Central Server creates sell (or buy) orders that are then transmitted to the Market Interface Server 18 for execution in the appropriate marketplace. The cash generated from the sweep vehicle sales is then provided by the Central Server for settlement to satisfy the now due settlement related to the purchases that created the debits in the borrowing customer's accounts. For simplicity purposes in this description, the executions and settlement information is returned via the Market Interface Server 18, however, these may be performed in other ways without departing from the scope of the present invention. The process is then repeated by the Central Server 11 each day based on the differential from the previous day.

Consequently, if the next day there were no changes with no new debits produced and no additional borrowings therefore to be financed, the sweep process and calculations by the Central Server 11 would reflect only the ordinary sweep activity. If the next day though there were additional debits that needed to be financed, the sweep processing calculations of the Central Server 11 would take again the aggregate of those debits and allocate them to accounts with cash sweep vehicles in whatever manner as described above was selected, sell the sweep vehicle from such accounts, generate cash and place free credits in the accounts and provide the cash for settlement to pay for the securities acquired on debit or otherwise to satisfy the brokerage's financing needs in connection with such debits.

Similarly, in the event debits are being reduced in the aggregate due to accounts, for example, selling securities that were purchased on margin, or customers' deleveraging by depositing cash to their accounts, etc. then the process by the Central Server 11 would be reversed based on the differential from the previously existing level of aggregate debits.

For example, if the debits were being reduced, the cash being generated from such sales or deleveraging would then be deducted from the customers' accounts that engaged in the deleveraging reflected as a reduction or elimination of the debit in such customers' accounts and the cash would then be used to buy the sweep vehicle for the account of customers for whom there exists current free credits, reducing the free credits. Again, that purchase and reduction of free credits can be allocated to accounts with free credits in a variety of ways with examples as described above.

The result is that the overall level of customer debits has been reduced, and so has the overall level of free credits which has been dynamically adjusted to approximate the amount of remaining debits. By this computer implemented method, no lock-up is required due to an imbalance caused by the free credits relative to the customer debits. Similarly, if there are a mixture of some accounts with increasing debits and some with decreasing debits, the calculation always looks to the net aggregates to ensure a single increase or decrease in free credits and then adjusts the aggregate of the free credits to equal the same amount.

The limitation on a brokerage's ability to fund customer debits then is solely the extent of the customer cash in sweep vehicles available for use by the brokerage, and any additional regulatory net capital requirement imposed. The result is that smaller brokerages—and even larger ones—can now grow and provide margin and fund customer debits in a very cost-efficient and expansive way with far greater resources available to the brokerage than would ordinarily exist.

Communications with the central server 11 occur via a network 13, which can be a private network, public network, Internet or some other communication device. Central server 11 performs all calculations and obtains all trading data via market server interface 18. Central server 11 creates all buy and sell orders and sends them for execution via market server interface 18. All data is maintained in database 15.

Turning to FIG. 2, shown therein is an exemplary embodiment of a method for managing cash in a brokerage according to one aspect of the present invention. According to the exemplary method 10, cash is swept out of selected investor accounts on a daily basis and used to purchase shares of a predetermined sweep security (step 21). When margin financing is required by the brokerage (step 22), the amount of cash needed for margin financing is obtained by selling the amount of shares in the predetermined sweep security (step 23). Free credits are then allocated among the selected investor accounts for which the predetermined sweep securities were sold.

Turning to FIG. 3, shown therein is another exemplary embodiment of a method for managing cash in a brokerage according to another aspect of the present invention. As with the method of FIG. 2, in method 30 cash is swept from selected investor accounts on a daily basis (step 31). An aggregate amount of margin financing is determined (step 32). The aggregate amount is allocated among selected investor accounts (step 33). The aggregate amount is deducted from an amount of the predetermined sweep security to be purchased that day (step 34). If the result is positive (step 35), then an amount of the sweep security equal to the result is purchased (step 36), with the remainder of the cash swept from the accounts which is equal to the aggregate amount is used for margin financing. If the result is negative, then an amount of the sweep security equal to the result is sold to generate the cash (step 37). Then, an aggregate amount of free credits is placed in selected investors accounts according to allocation and the aggregate amount of cash is used for margin financing (step 38).

Any investment vehicle that allows for ready access to the funds could be used for the cash sweep vehicle. Money market funds or money market accounts can be employed for these cash sweep vehicles.

1. A computer implemented method for managing cash in a brokerage comprising:
storing information regarding a plurality of investor accounts in a database;
providing a daily cash sweep mechanism for the brokerage's investor accounts, where cash is moved on a daily basis as needed from, or to, one or more selected investor accounts of the plurality of investor accounts to deposit or raise cash with respect to one or more selected investor accounts as necessary on a daily basis, thereby creating for each day one or more selected investor accounts with cash invested in or being removed from the cash sweep mechanism (a “regular sweep program”); and
on a given day, aggregating by computer the amount of the buys and sells into the regular sweep program based on the ordinary non-margin, non-borrowing activity of the one or more investors where such buys and sells are due to settlement of purchases or sales of securities, receipt of cash dividends, withdrawals from the brokerage, or other usual investor activity (the “net regular sweep amount”); and
on a given day, aggregating by computer the amount of the cash either required for settlement for, or being recovered from margin balances for the benefit of, the margin investor accounts of the plurality of investor accounts requiring (increasing) or decreasing their margin financing, determining by a computer an aggregate amount of net margin financing (the amount required due to increases in margin less the amount being recovered from decreases in margin balances) required by the brokerage for the given day for the one or more margin investor accounts (the “net margin sweep amount”); and
deducting the aggregate net margin sweep amount from the net regular sweep amount (the “net total result”), wherein:
if the net total result is positive, then purchasing an amount of the sweep mechanism equal to the net total result and placing an amount of free credits equal to the net margin sweep amount in the one or more selected investors' accounts based on said allocating; and
if the net total result is negative, then selling an amount of the sweep mechanism equal to the absolute value of the net total result and placing an amount of free credits equal to the net margin sweep amount in the one or more selected investors' accounts based on said allocating; and
using the aggregate amount of cash as margin financing for the one or more margin investor accounts.

2. The method according to claim 1, wherein said allocating includes allocating the aggregate amount pro rata based on an amount of cash available to the sweep mechanism.

3. The method according to claim 1, wherein said allocating includes allocating the aggregate amount pro rata based on an amount of cash in the applicable investor accounts.

4. The method according to claim 1, wherein said allocating includes allocating the aggregate amount randomly.

5. The method according to claim 1, wherein said allocating includes allocating the aggregate amount in an order based on each account's existing cash sweep mechanism holdings from largest to smallest.

6. The method according to claim 1, wherein said allocating includes allocating the aggregate amount in an order based on each account's existing cash sweep mechanism holdings from smallest to largest.

7. The method according to claim 1, wherein said allocating includes allocating the aggregate amount first to those accounts for which the investor has affirmatively opted-in.

8. (canceled)

9. (canceled)

10. (canceled)

11. (canceled)

12. (canceled)
